(19) United States
(12) Patent Application Publication
(10) Pub. No.: US 2010/0031157 A1
(43) Pub. Date: Feb. 4, 2010

(54) SYSTEM THAT ENABLES A USER TO ADJUST RESOURCES ALLOCATED TO A GROUP

(76) Inventors: Robert Neer, Seattle, WA (US); Rebecca Sparks, Seattle, WA (US)

Correspondence Address: PERKINS COIE LLP;PATENT-SEA, P.O. BOX 1247, SEATTLE, WA, 98111-1247, US

(21) Appl. No.: 12/246,439

(22) Filed: Oct. 6, 2008

Related U.S. Application Data
(60) Provisional application No. 61/084,922, filed on Jul. 30, 2008.

(51) Int. Cl. G06F 3/048

(52) U.S. Cl. 715/738

(57) ABSTRACT

A system that allows a user to allocate one or more resources among members of a group, such as resources shared among a group in a telecommunications service plan. The system generates a user interface having a slider associated with each member of the group that shares a resource. Each slider includes a scale to display the amount of the resource that is allocated to the member, as well as an adjustable slider bar that may be moved along the slider in order to increase or decrease the amount of the resource that is allocated to the member. In addition to displaying the amount of the resource allocated to the associated member, each slider may also display the amount of the resource consumed by that member within a corresponding billing or reporting period.

### CROSS-REFERENCE TO RELATED APPLICATION

This application claims the benefit of U.S. Provisional Application No. 61/084,922 entitled “SYSTEM THAT ENABLES A USER TO ADJUST TELECOMMUNICATIONS RESOURCES ALLOCATED TO A GROUP,” filed Jul. 30, 2008.

### BACKGROUND

Telecommunications providers typically offer service plans to subscribers that bundle a variety of different services. For example, a wireless phone plan offered by a wireless telephone company will usually include a text messaging and a downloading service in addition to a voice service. The quantity of each resource provided under a service plan is limited, and the service plan is usually tied to only a single user. In order to avoid using more resources than are provided under the service plan, the user may be allowed to monitor his or her resource usage, such as by calling the service provider or sending a text message to receive the amount of voice minutes remaining in any month.

While it is easy for a single user to track resource use under a service plan, problems may arise when multiple users share a service plan's resources. For example, family members may share a group plan offering a limited quantity of minutes, text messages, and downloads. While a family member may be aware of his/her own resource use during a billing period, it is unlikely that the family member would be aware of the other family members' use during the billing period. Problems may arise for family members lacking such information. A family member may use a disproportionate amount of the family's telecommunications resources, or the family as a whole may unknowingly use more resources than are provided under the family's shared plan. Exceeding the plan's limits may result in extra charges being levied against the family. Family members fearing such charges may therefore not fully utilize all the resources that their shared plan provides. To help alleviate these and other problems associated with shared service plans, it would be beneficial for customers if they could easily monitor, manage and allocate the various telecommunications resources available under a shared service plan.

### BRIEF DESCRIPTION OF THE DRAWINGS

FIG. 1A is a diagram of an environment in which a system for generating a user interface that allows the management of resources under a telecommunications service plan operates.

FIG. 1B is a block diagram of system components that enable the management of resources under a telecommunications service plan.

FIGS. 2A-2C depict various settings of an interface that is presented to a user to allow the user to manage the allocation of resources under a shared telecommunications service plan.

FIG. 3 is a representative table such as might be used for organizing data associated with a shared telecommunications service plan.

FIG. 4 is a flow chart of a process implemented by a system for disabling a member's service under a shared telecommunications service plan.

FIG. 5 is an interface that is presented to a user to allow the user to manage an individual member's resource allocation under a shared telecommunications service plan.

FIG. 6 is an alternative interface that is presented to a user to allow the user to manage an individual member's resource allocation under a shared telecommunications service plan.

### DETAILED DESCRIPTION

A hardware and/or software system is disclosed that allows a user to allocate or apportion one or more resources among members of a group, such as a group who share one or more resources under a shared telecommunications service plan. The system generates a user interface having a slider associated with each member of the group. Each slider includes a scale to display the amount of a resource that is allocated to the member, as well as an adjustable slider bar that may be moved along the slider in order to increase or decrease the amount of the resource that is allocated to the member. In addition to displaying the amount of the resource allocated to the associated member, each slider also displays the amount of the resource consumed by that member. For instance, if the sliders are applied to a shared telecommunications service plan, each slider may display the amount of the resource consumed by that member within a corresponding service plan billing or reporting period (e.g. month, quarter, year, etc.). An advantage of the sliders generated by the system is that the sliders accurately display important information to a user and in a single interface that allows the user to easily adjust the allocation of a shared resource.

In some embodiments, the system displays a group slider that reflects the sum of all resources assigned to each member of a group. As a user adjusts the position of a slider bar on a member's slider, the system may automatically adjust the position of the slider bar on the group slider to reflect the corresponding change to the resources allocated to the group. By displaying an aggregate picture of all group members, the system enables a user to quickly and easily see when plan resources have been exceeded by the group, or when there are remaining resources that can be distributed to the group.

Various embodiments of the invention will now be described. The following description provides specific details for a thorough understanding and an enabling description of these embodiments. One skilled in the art will understand, however, that the invention may be practiced without many of these details. Additionally, some well-known structures or functions may not be shown or described in detail, so as to avoid unnecessarily obscuring the relevant description of the various embodiments. The terminology used in the description presented below is intended to be interpreted in its broadest reasonable manner, even though it is being used in conjunction with a detailed description of certain specific embodiments of the invention.

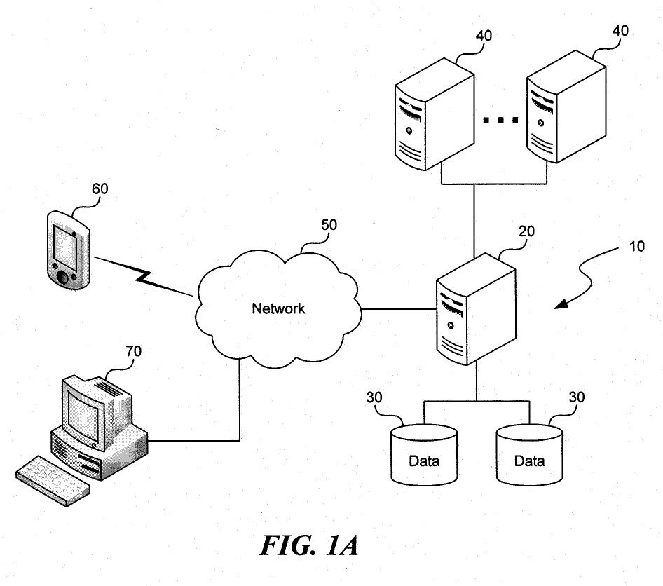

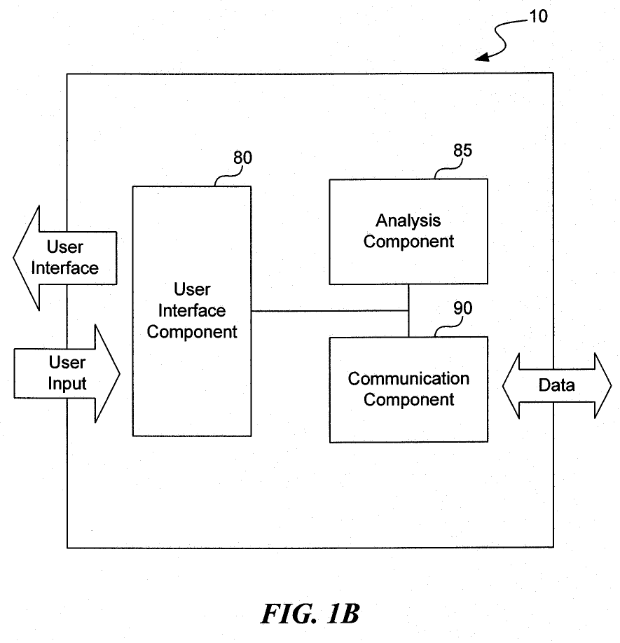

FIG. 1A depicts an environment in which a system 10 for generating a user interface to allow a user to allocate or apportion one or more resources among members of a group may operate. In the depicted example, the system is deployed or utilized by a telecommunication service provider that offers telecommunications services to mobile or non-mobile devices. The system allows subscribers to manage the allocation of resources within a telecommunications service plan. The system 10 operates on one or more servers 20 or other computing devices connected to one or more data storage areas 30. Data storage areas contain group data, member account data, and software routines necessary to implement the functionality disclosed herein. The servers 20 can communicate with one or more billing, management, and control systems 40 of the telecommunication service provider. The system 10 generates a user interface that allows a user to view and adjust the amount of telecommunications resources allocated to group members under a telecommunications service plan. A user may access the interface via mobile devices 60 or computers 70 that communicate with servers 20 through public or private networks 50, such as the Internet or a wireless communication network. Changes made by a user to the allocation of resources across a group are transmitted to the telecommunications service provider's billing, management, and control systems 40 where the changes are implemented for service and billing purposes.

Those skilled in the art will appreciate that the system 10 may be implemented on any computing system or device. Suitable computing systems or devices include personal computers, server computers, hand-held or laptop devices, multiprocessor systems, microprocessor-based systems, programmable consumer electronics, network devices, minicomputers, mainframe computers, distributed computing environments that include any of the foregoing, and the like. Such computing systems or devices may include one or more processors that execute software to perform the functions described herein. Processors include programmable general-purpose or special-purpose microprocessors, programmable controllers, application specific integrated circuits (ASICs), programmable logic devices (PLDs), or the like, or a combination of such devices. Software may be stored in memory, such as random access memory (RAM), read-only memory (ROM), flash memory, or the like, or a combination of such components. Software may also be stored in one or more storage devices, such as magnetic or optical based disks, flash memory devices, or any other type of non-volatile storage medium for storing data. Software may include one or more program modules which include routines, programs, objects, components, data structures, and so on that perform particular tasks or implement particular abstract data types. The functionality of the program modules may be combined or distributed as desired in various embodiments.

While the system 10 is depicted and primarily described herein as generating an interface for the management of resources in a shared telecommunication service plan, it will be appreciated that the system may be applied to any other application or service having shared resources. For example, the system may be used to generate a user interface that allows a member to decide how resources will be allocated in a music download service (e.g., to decide how a fixed amount of downloads available on a monthly basis will be distributed to group members). As another example, the system may be used to allow a user to set limits on a shared financial account (e.g., to enable access of a family member to a percentage of a deposit account). As still another example, the system may be used by a manager to allocate access to a credit facility that employees of a small business may draw upon. Those skilled in the art will appreciate the broad number of additional applications or services with which the system may be used.

FIG. 1B is a block diagram of components in the system 10 that enable the management of one or more resources among members of a group, such as the management of resources in a telecommunications service plan. The system includes a user interface component 80 that allows a user to communicate with the system. The user interface component 80 generates an interface that is displayed to the user. The user interface component also receives input from a user as the user manipulates elements of the user interface using a computer mouse, keyboard, touchscreen, or any other input device that is typically provided in computing systems or devices to manipulate a computer interface. User input received by the user interface component is provided to an analysis component 85. The analysis component 85 processes data that it receives and determines what, if any, changes need to be made to the telecommunications service plan of the user based on the manipulations of the user interface by the user. Such changes may include re-allocation of resources or disabling of access to a resource or service. The analysis component 85 is coupled to a communication component 90, which sends and receives data to and from external databases and systems. The communication component 90 receives resource use data and communicates changes to the telecommunications service plan to the telecommunications service provider's billing, management, and control systems where the changes are implemented for service and billing purposes.

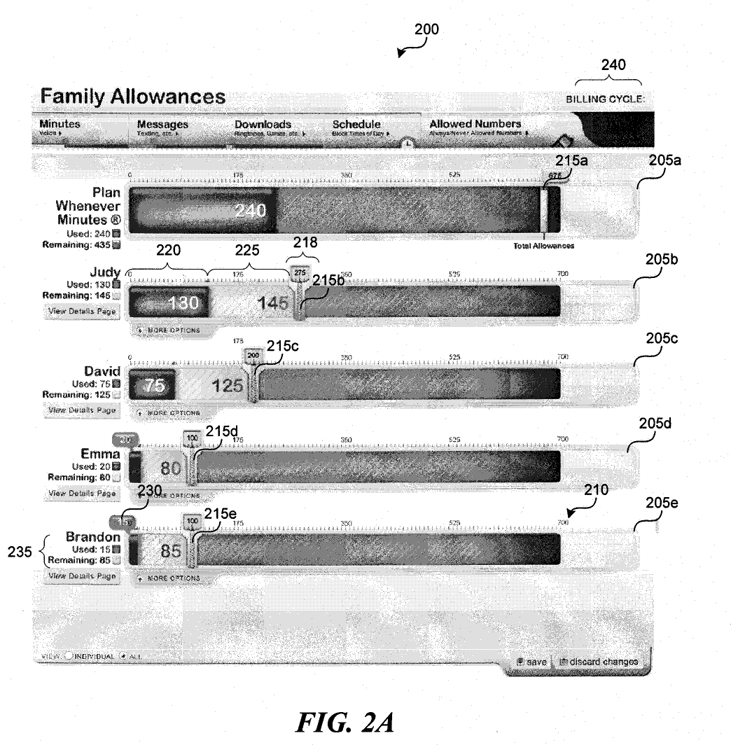

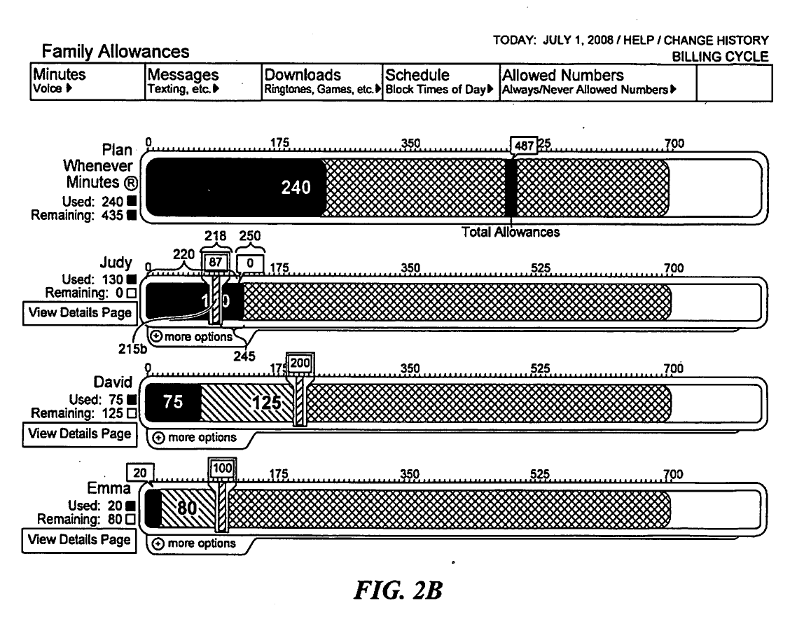

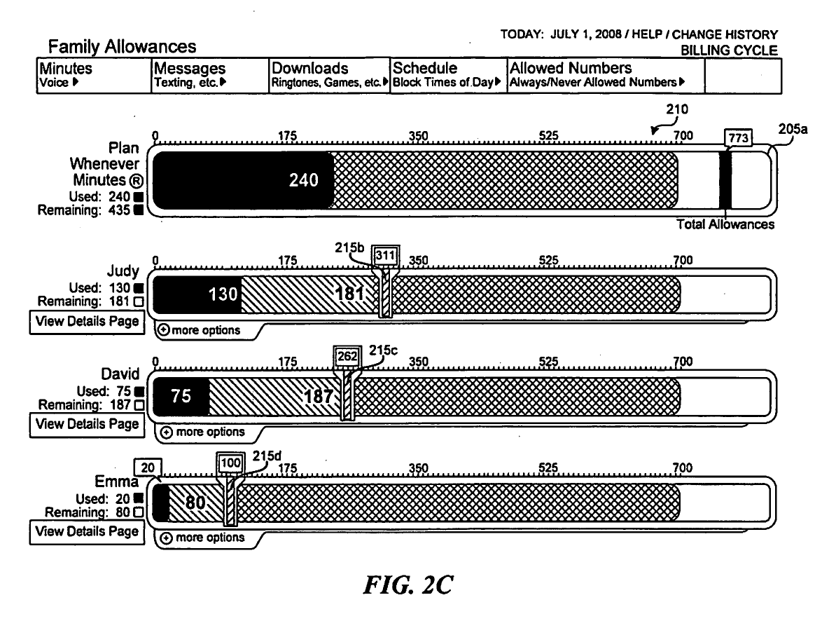

FIG. 2A depicts a representative user interface 200 that may be generated by the system. In FIG. 2A, five sliders 205a-205e are depicted to allow a user to allocate telecommunications resources across a group having four members. A group may consist of any members that share a telecommunications service plan, such as a family, a business, an organization, a group of friends, or the like. Groups may also include sub-groups, such as children within a family. The top slider 205a is a group slider, representing the sum of the resources allocated or consumed by the four members in the group (labeled “Judy,” David,” “Emma,” and “Brandon”). The remaining four sliders 205b-205e are individual member sliders, one for each of the four members of the group. As will be described in additional detail herein, each slider serves multiple purposes in the user interface generated by the system. A slider allows a user to set a resource allocation of a shared telecommunications service plan. A slider also displays the amount of the resources consumed as of the time when the user interface is accessed. A slider therefore acts as both a control interface and reporting interface to make it easier for a user to manage the shared service plan.

In some embodiments, one or more security protocols (e.g., password protection) may be implemented to ensure that only authorized users are allowed to access the user interface 200 and manage the shared service plan. In some embodiments, only one user may have access to the user interface to manage the shared service plan. The user having access and managerial control may be a group member, or the user may be a third party outside of the group. Other members of the group not having managerial privileges may be granted access to view the user interface or may be prohibited from viewing the user interface.

In the representative interface in FIG. 2A, the sliders 205a-205e are configured to allow a user to allocate allowed minutes in a telecommunication service plan across the members of the group. In the depicted service plan, the group is collectively allowed 700 minutes each billing or reporting period (typically monthly, although other periods may apply). Consequently, each of the five sliders 205a-205e has a scale 205a that is 700 minutes in length. To allocate the 700 minutes across the group, a user adjusts the position of a slider bar 215a-215e on each member's slider. A user may utilize any system input device, such as a mouse, keyboard, touchscreen, or keypad, to adjust the position of the slider bar. When a user drags a slider bar left, the number of minutes allocated to the corresponding member decreases. When the user drags a slider bar right, the number of minutes allocated to the corresponding member increases. For example, Judy's slider 205b in FIG. 2A has a slider bar 215b in a position that indicates that 275 minutes have been allocated to Judy (275 minutes is represented by a text tag 218 above the slider bar and also by the relative position of the slider bar 215b with respect to the scale at the top of the slider). Moving the slider bar 215b to the left on Judy's slider would decrease the number of minutes allocated to Judy (i.e., to a number less than 275), and moving the slider bar to the right on Judy's slider would increase the number of minutes allocated to Judy (i.e., to a number greater than 275). Rather than move a slider bar, in some embodiments, a user may alternatively select a slider bar and enter with a keyboard, keypad, or other input device, the precise number of minutes to allocate to the individual. In such circumstances, the system may move the slider bar to the specified number of minutes on the slider after the user has entered the number.

In some embodiments, when a user increases a member's allocated minutes, the system may automatically adjust the group slider 205a to reflect the impact that the individual allocation has on the rest of the group. For example, if a user moves Judy's slider bar 215b to the left, reducing the minutes allocated to Judy, the system may automatically move the group slider bar 215a to the left as well. By automatically moving the location of the slider bar 215a on the group slider 205a whenever a member's slider bar 215b-e is adjusted, a user can easily determine how close the group is to the total allocation of minutes that are allowed under the corresponding telecommunications service plan by referring to the visual display provided by the group slider 205a.

In some embodiments, instead of presenting a group slider 205a to allow the user to easily see the aggregate service plan resources allocated to the group members, the system may present a counter, a pie chart, or other visual indicator that displays the total number of minutes that remain available to be allocated to individual members. The system decrements or increases the visual indicator to reflect the distribution to or return of resources to group members.

It will be appreciated that the depicted scale 205a on the sliders is only representative, and the scale of a slider may vary depending on the amount of resources to be allocated. In circumstances when, for example, a telecommunications service plan includes only 400 minutes, the scale 205a of each slider may be adjusted to 400 minutes in length. In other circumstances, a slider's scale may be larger than the number of minutes included in the group's plan. Regardless of the scale, the actual size of the slider generated by the system typically does not change since the slider is sized by the system to ensure clarity and usability by a user.

In addition to allowing a user to allocate telecommunications resources, in some embodiments the system displays the current resource consumption on the sliders. As depicted in FIG. 2A, the sliders 205b-205e of the group members have a dark band 220 and a lighter band 225, each band containing a number. The dark band 220 reflects the current usage of the resource, and the lighter band 225 reflects the remaining available usage before the member reaches the allocated amount set by the position of the slider bar. For example, Judy's slider 205b reflects that she has currently used 130 minutes (as specified in dark band 220) and has 145 minutes remaining (as specified in lighter band 225) until reaching the allocated number of 275 minutes. The 130 minutes reflects the amount of resources used at the time that the system is accessed. If a user were to access the interface 200 at a later time, the 130 minutes would be updated to reflect the current usage by Judy. The system obtains an accurate measurement of current resource use by making a service call or other request to the systems of the telecommunications service provider at or near the time the interface is generated. The group slider 205a may display the aggregate use of all members in the group. For example, the group slider 205a in FIG. 2A shows that the group has already used 240 minutes of the 700 minutes that the group is allowed under its service plan. While not pictured in FIG. 2A, the system may also display the minutes remaining on the group slider 205a.

When the band in a slider (either the dark band 200 or lighter band 225) becomes too small to display a current use or remaining available use number, the number may be represented above or below the slider in a bubble 230, such as the 15 minutes that are depicted as having been used on Brandon's slider 215e. To highlight the distinction between used resources and still available resources, various colors may be applied to the bands. For example, used resources may be shown in red and remaining resources shown in green. In addition to graphically displaying the amount of used resources on the slider, the system may also display the number of used, remaining, and total minutes in a region 235 located under the name of the slider.

Although the group slider 205a has been previously described as serving only to display the sum of the allocations to group members, in some embodiments the group slider 205a may be used to set the total amount of resources that should be allocated. For example, the system may allow a user to assign percentages to each member in the group (e.g., 50% to Judy, 30% to David, 15% to Emma, and 15% to Brandon). If members have assigned percentages, the user may be allowed to adjust the slider bar 215a on the group slider 205a and have the set allowance automatically allocated to the individual members in proportion to the entered percentages. In doing so, the system may automatically adjust the corresponding member slider bars 215b-e. For example, in FIG. 2A, if a user drags the slider bar 215a on the group slider 205a to the left, decreasing the total minute allowance for the group, the system may automatically decrease the allocated group member minutes by an amount dictated by the assigned percentages. Other mathematical transformations may, of course, be used to convert motion of the slider bar 215a on the group slider 205a to allocations to each member.

In some embodiments, the system may allow a user to add members to or delete members from the group. For example, the system may allow a user to enter new member information that results in the addition of another slider to the user interface 200. Alternatively, a user may request that a service provider add a member to a group. When a new member is added to a group, the member may initially be allocated no telecommunications resources, the member may be allocated a fixed amount of telecommunications resources, or the member may receive a pro-rata portion of allocated telecommunications resources. Similarly, if a member is removed from a group, the removed member's telecommunications resources may be automatically distributed to the other members of the group on a fixed or pro-rata basis, or may be returned to a group pool for subsequent allocation.

In some embodiments, the system may allow a user to select and manage different billing or reporting periods than the default period that is displayed by the system. For example, the system may display by default the current billing or reporting period, such as the current month. The billing or reporting period that is being displayed to the user may be indicated in a region 240 on the interface 200. The user may select a different period, such as the next month, and pre-allocate the telecommunications resources for that period. In some embodiments, the system may allow a user to pre-allocate telecommunications resources for a billing or reporting period based on a resource allocation from a previous period. For example, a user may elect to allocate telecommunications resources for the month of August by the same proportion as the user allocated the telecommunications resources for the month of June. In general, the immediately preceding billing or reporting period may be used as a default allocation by the system for the next billing or reporting period, or the system may allow a user to select any prior billing or reporting period to use as an initial template for the next billing or reporting period.

In some embodiments, the system may generate other graphical user interface components other than sliders. For example, the system may generate rotary dials that allow a user to adjust an allocation of resources by turning each rotary dial. The rotary dials may display current use data and allows a user to adjust an allocation of resources with reference to the same circular scale. One skilled in the art will appreciate that the disclosed techniques can be extended to any graphical elements that display use and allow allocation on a common measurement scale.

Although the example depicted in FIG. 2A and the other examples detailed below describe the system in the context of allocating voice minutes under a telecommunications service plan, one skilled in the art will appreciate that a slider may control the allocation of text messages, downloads, data, or any other resource of a telecommunications service plan as well.

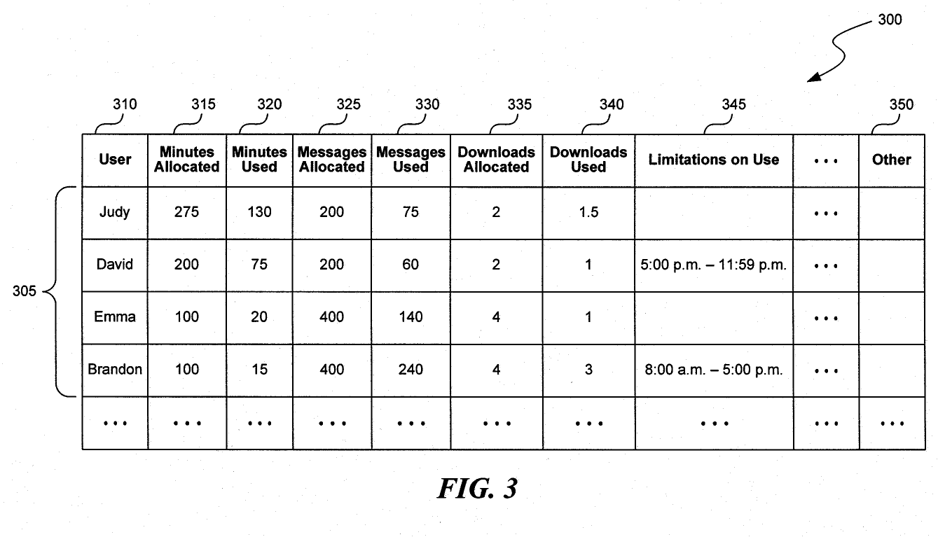

Once data relating to a group's usage and allocation of a telecommunications resource is collected, the data is stored in a manner accessible and actionable by the system. FIG. 3 depicts a representative table 300 showing the members of a group and the corresponding data associated with the members' resource allocation and usage. Each row 305 in the table represents a group member, and each column in the table contains data characterizing or associated with each member. It will be appreciated that more rows 305 may be added to the table, or rows may be removed from the table, if a member is added or removed from a group. A first column 310 contains a user name that is assigned to each of the group's members (as depicted, “Judy,” “David,” “Emma,” and “Brandon”). A second column 315 and a third column 320 are used to store the minutes allocated to a group member and minutes used by a group member, respectively. For example, Judy has used 130 minutes of the 275 minutes that are allocated to her. A fourth column 325 and a fifth column 330 are used to store the number of messages allocated to a group member and number of messages sent/received by a group member, respectively. For example, Judy has used 75 messages of the 200 messages that have been allocated to her. A sixth column 335 and seventh column 340 are used to store the size of downloads allocated to a group member and the size of downloads used by a group member, respectively. The size of downloads may be measured in kilobytes, megabytes, or other unit of data transfer. For example, Judy has used 1.5 megabytes of download capacity of the 2 megabytes of download capacity that is allocated to her. An eighth column 345 is used to store an indication of any temporal limitations on a member's use of the telecommunication services. For example, Brandon is only allowed to use telecommunications resources between the hours of 8:00 a.m. and 5:00 p.m. It will be appreciated that additional data characterizing or associated with each member and the telecommunications resources that they use may be added to the table by adding additional columns 350 to the table. While FIG. 3 shows a table whose contents and organization are designed to make them more comprehensible by a human reader, those skilled in the art will appreciate that actual data structures used by the facility to store this information may differ from the table shown, in that they, for example, may be organized in a different manner, may contain more or less information than shown, may be compressed and/or encrypted, etc.

In some embodiments, a user may want to restrict a member's account so that the member can no longer receive telecommunication services. To do so, a user may move a member's slider bar to a position that is less than the amount of resource already used by the member. FIG. 2B depicts circumstances under which a user has disabled access to the resource of one member in a group. In the depicted example, a user has adjusted Judy's slider bar 215b to a position where the allocated minutes to Judy are less than the number of minutes that Judy has already used. That is, the position of the slider bar 215b indicates that Judy has been allocated 87 minutes (as indicated in the text tag 218 above the slider) even though Judy has already used 130 minutes (as indicated by the size of the dark band 220). Consequently, Judy may not be allowed to place any additional calls under the service plan unless and until a user increases Judy's minute allocation by sliding Judy's slider bar 215b to the right, beyond the number of minutes that Judy has already used. The system indicates that Judy's access to a resource has been disabled by displaying one or more visual cues to the user. For example, the color of the slider between the slider bar and the total minutes (i.e., at a region 245) may be changed to a warning color such as red. The system may also display that Judy has zero remaining minutes in a text bubble 250. In some embodiments, the system may allow Judy to make emergency calls or calls to only specified numbers (e.g., to a home phone number) despite having zero remaining minutes allocated for her use.

In addition to restricting access to a resource when the user has exceeded his/her allocation of the resource, the system may also automatically disable all resources used by a member or any portion thereof under a service plan. For example, if a member receives voice, messages, and downloads under a service plan, and if the member exceeds the allocated number of voice minutes within a particular billing period, the member's message and download resources may be suspended in addition to suspending voice access until the subsequent billing period. In general, a resource may be disabled when a user exceeds the allocated amount for that resource, some resources may be disabled when a user exceeds the allocated amount of a resource, or all resources may be disabled when a user exceeds the allocated amount for a resource.

When a user moves a member's slider bar and it reaches the total number of minutes already used, the system may display an alert to the user that the member's access to that resource will be disabled. Such an alert may include a pop-up window, a noise, a visual alert, or any other alert that indicates to the user that the system will disable the member's access to the resource. If the resource is voice minutes for a mobile phone plan, the alert may also include an option to allow the user to enter or otherwise designate telephone numbers that the member is still allowed to call. For example, if a user were a parent of Judy, the user may desire to allow Judy the option of calling home, but otherwise disable Judy's voice service. In some embodiments, the system may not allow a user to move a member's slider bar to the left beyond the indicated resource use by the member. That is, the system will not allow a user to move a member's slider bar to a position that immediately disables the member's access to that resource.

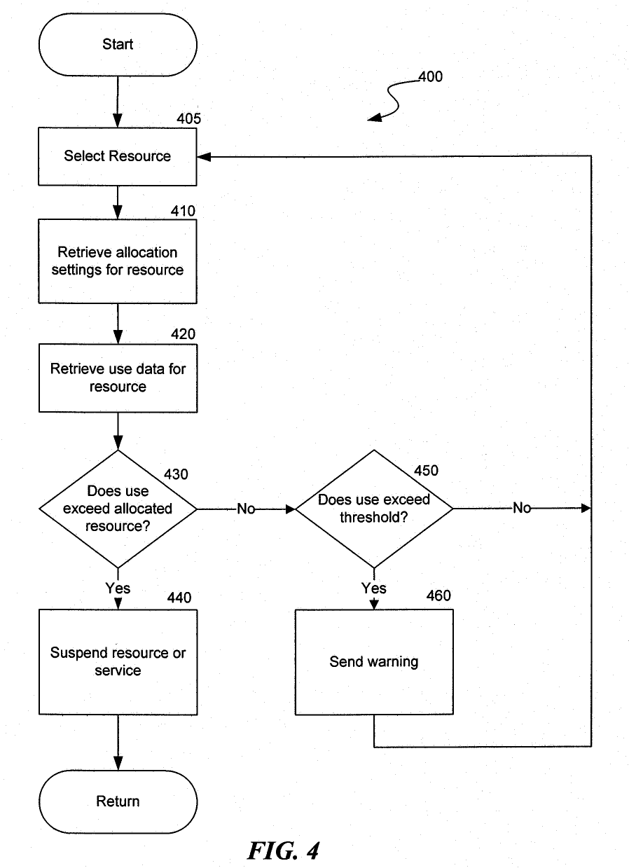

FIG. 4 is a flow chart of a process 400 implemented by the system to disable a member's resource or service when the member has exceeded their allocated amount of resource. At a block 405, the system selects a particular resource that is to be checked. For example, the system may check the number of minutes used by a member, the number of messages sent or received by a member, or any other resource in a member's service plan that has a limitation on use. At a block 410, the system retrieves allocation settings that were made by a user for the selected resource in the member's shared telecommunications service plan. The settings are retrieved from the data storage area. At a block 420, the system retrieves use data pertaining to the selected member and resource. Use data may include, for example, the current number of minutes used by the member or the current number of messages sent or received by the user. At a decision block 430, the system compares the allocation settings retrieved at block 410 with the use data retrieved at block 420 to determine if the member's use of a particular resource equals or exceeds the member's allocation of that resource. If the member's use equals or exceeds the allocation of a resource, the system proceeds to a block 440 where the member's resource use or overall service is suspended. In some embodiments, the system suspends all telecommunications services used by the member, while in other embodiments the system only suspends the resource in which the member has exceeded his/her allocation. Once a member's resource use or service is suspended, the process 400 is complete.

If at decision block 430 the system determines that the member's use of a particular resource is less than the member's allocation of the resource, the system proceeds to a decision block 450. At decision block 450, the system compares the allocation settings retrieved at block 410 with the use data retrieved at block 420 to see if the use by the member equals or exceeds a threshold warning level. The threshold warning level is set by the system to provide a warning to a member that they are close to, but have not yet reached, their allocation for a resource. For example, the system may be set to warn a member when a member has used 85% of their allocated minutes for a particular billing period. As another example, the system may be set to warn a member when the member sends their 90th SMS message, which the member has an allocation of 100 SMS messages per month. If the member's use of a particular resource exceeds the threshold warning level for that resource, at a block 460 the system sends a warning to the member indicating that the member has exceeded the threshold warning level. The system may, for example, warn the member via a text message, an email, an automated voice call, or any other acceptable means of communication, that the member's use of a resource has almost reached the member's allocation of the resource. If, however, the member's use of the resource does not exceed the threshold warning level for the resource, the system loops back to block 405 in order to continue to monitor the member's use of resources.

In some embodiments, the system allows a user to allocate more minutes to group members than are provided under the group's telecommunications service plan. As an example, in FIG. 2C a user has increased Judy and David's minutes to the point that the sum of the minutes allocated to the group is 773 minutes. As shown by the position of the slider bar 215a on the group slider 205a, 773 minutes exceeds the number of minutes that are provided under the service plan (i.e., the allocated 773 minutes exceeds the 700 minutes allowed by the plan). To indicate that the total allocated minutes exceeds the service plan's allowed minutes, the slider bar 215a is displayed beyond the end of the slider scale 210. The slider 215a and/or slider bar 205a may also change appearance, such as by changing color or texture, to highlight that the user may face additional service charges outside of their normal plan charges if they exceed the amount allowed under the service plan.

In some embodiments, a user may specify that the system should never allow the allocation of more minutes than are designated under the user's telecommunications service plan. In such embodiments, the user may not be allowed to increase the number of minutes allowed to a particular group member if doing so would increase the total group allowance beyond the number of minutes under the service plan. For example, in FIG. 2C the system may stop a user from sliding a group member's slider bar 215b-215e any further to the right when the slider bar 215a on the group slider 205a reaches the end of the slider scale (i.e., at 700 minutes).

In some embodiments, the system may allow a user to slide a group member's slider bar 215b-215e to the right, but the system may stop the group slider bar 215a at the end of the slider scale, which is the total number of minutes allowed under the service plan. The system may then display to the user an indication of the total number of minutes that the user must then take away from other members of the group in order to meet the service plan's total minute allocation. Using FIG. 2C as an example, the system may stop the slider bar 215a on the group slider 205a at 700 minutes, indicate to the user that the sum of Judy, David, Emma, and Brandon's (not pictured) allowances is greater than 700 minutes, and display to the user how many minutes the user must reduce Judy, David, Emma, and/or Brandon's allocation in order to reduce the group slider bar 215a to 700 minutes or lower. The user may then adjust the group's allocation of minutes in order to meet the service plan's total allowance.

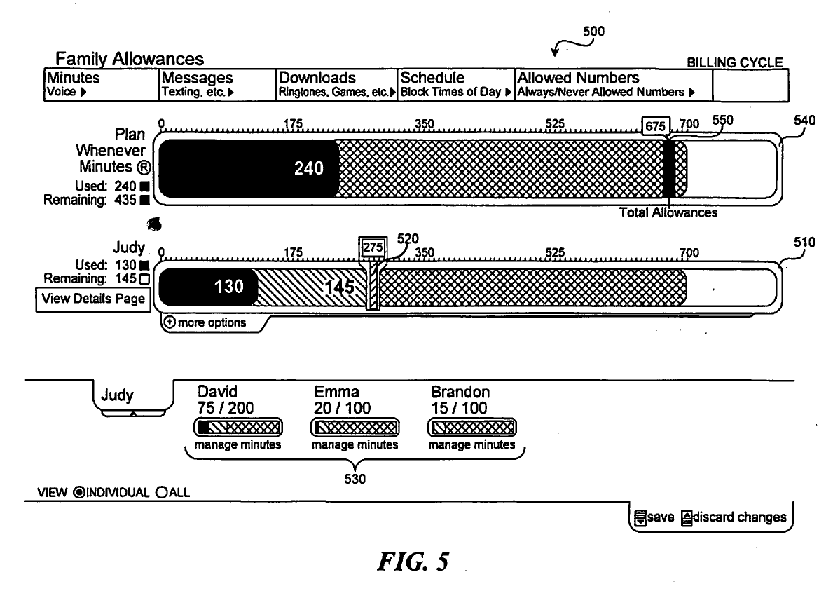

In some embodiments, the system may allow a user to view a particular member's slider independent of the sliders of the other group members. FIG. 5, for example, is an interface 500 that is generated by the system and displayed to a user to allow the user to manage an individual member's resource allocation. In FIG. 5 the system displays a slider 510 for Judy, while removing the sliders for David, Emma, and Brandon. In a similar fashion to the interface described with respect to FIG. 2, Judy's slider 510 may indicate the total number of minutes Judy has used (130 minutes), the total number of minutes that remain for Judy to use (145 minutes), and the total number of minutes allowed for Judy (275 minutes). A user may adjust the number of minutes allowed for Judy by moving a slider bar 520 left or right. A summary for each of the other members in the group is provided on tabs 530 that are at the bottom of the user interface 500, and individual pages associated with each of the listed members may be accessed by selecting the appropriate tab.

In some embodiments, the system may also display a group slider along with a member slider that is displayed independent from the other members of the group. For example, in FIG. 5 a group slider 540 is depicted above Judy's slider 510. The group slider 540 may be automatically adjusted to reflect changes made to Judy's slider 510. That is, if a user reduces the number of minutes allowed for Judy, the system may automatically adjust the position of the slider bar 550 on the group slider 540.

In some embodiments, tabs 530 may display information about the group members that the user has not selected for a detailed view. For example, in FIG. 5 the system indicates that David has used 75 minutes and has 200 minutes total that are allowed to him. The user may select David's tab in order to switch to an interface containing only David's slider, similar to the display of Judy's slider 510 that is depicted in FIG. 5.

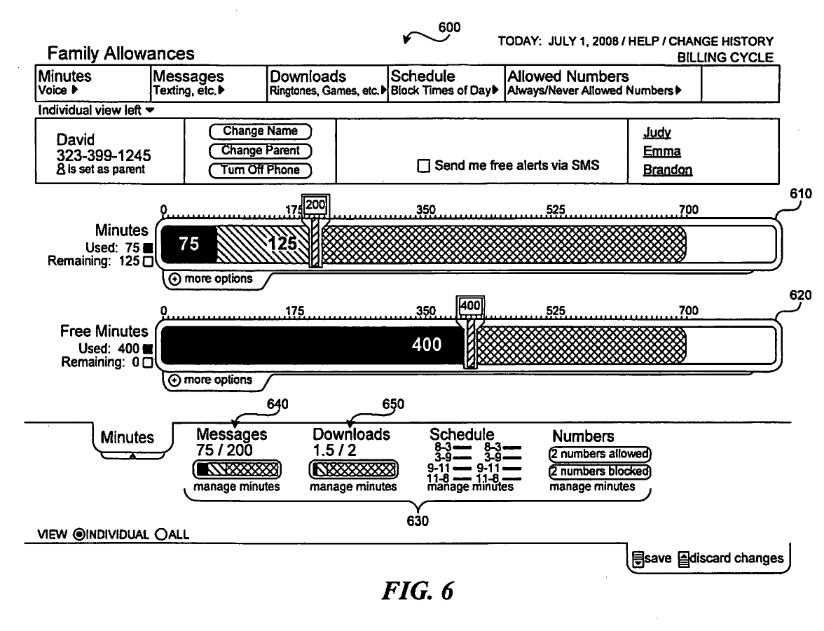

In some embodiments, the system may display a detailed view of a member's telecommunications resource allocation and usage. FIG. 6, for example, is an alternative interface 600 that is displayed to a user to allow the user to manage an individual member's resource allocation. FIG. 6 depicts a detailed view of two resource sliders related to David that are generated by the system. A first resource slider 610 is related to charged minutes available under a telecommunications service plan, and a second resource slider 620 is related to free minutes under the telecommunications service plan. In addition to the displayed sliders pertaining to minutes, a user may access other sliders that pertain to additional telecommunications resources associated with the group member by selecting various tabs 630 at the bottom of the interface. For example, a user may select a “Messages” tab 640 to view a message slider and allocate the number of messages that the member may receive. A user may also select a “Downloads” tab 650 to view a slider that allows the user to allocate the amount of downloads that the member may receive. Other tabs may be envisioned that would allow the user to access additional sliders and control the allocation of other communications resources. In some embodiments, the system may display more than one slider simultaneously, such as the simultaneous display of sliders for a group member's minutes, messages, downloads, and data.

Those skilled in the art will appreciate that changes made by a user using any of the interfaces described herein are transmitted by the system to the telecommunications service provider. The changes are implemented by one or more back-end systems operated or utilized by the service provider for service and billing purposes. Preferably, the system generates the interfaces and implements any changes on a timely basis so that users and members can rely on the accuracy of the displayed information.

Those skilled in the art will also appreciate that various implementation changes may be made to the system. For example, the system can be implemented in distributed computing environments, where tasks or modules are performed by remote processing devices, which are linked through a communications network, such as a Local Area Network (“LAN”), Wide Area Network (“WAN”) or the Internet. In a distributed computing environment, program modules or sub-routines may be located in both local and remote memory storage devices. Aspects of the system described herein may be stored or distributed on computer-readable media, including magnetic and optically readable and removable computer discs, stored as firmware in chips (e.g., EEPROM chips), as well as distributed electronically over the Internet or over other networks (including wireless networks). Those skilled in the relevant art will recognize that portions of the invention may reside on a server computer, while corresponding portions reside on a client computer. Data structures and transmission of data particular to aspects of the invention are also encompassed within the scope of the invention.

I/We claim:

1. A computer-implemented method of generating an interface that allows a user to allocate a shared resource to members of a group, the method comprising:
displaying to a user a plurality of sliders that are associated with a resource that is shared among a group of members, each of the plurality of sliders being associated with a different member in the group of members;
retrieving data reflecting a current use of the resource by each member in the group of members;
for each of the plurality of sliders, displaying to the user an indication of the current use of the resource by the member associated with each slider;
displaying to the user a slider bar on each of the plurality of sliders, each slider bar being moveable by the user on the corresponding slider, wherein the position of the slider bar on the corresponding slider reflects an allocation of the resource to the member associated with that slider;
receiving from the user a movement of a slider bar on one of the plurality of sliders; and
allocating the resource in accordance with the received movement of the slider bar.

2. The computer-implemented method of claim 1, wherein the resource is part of a shared telecommunications service plan.

3. The computer-implemented method of claim 2, wherein the resource is selected from the group consisting of minutes, messages, and downloads.

4. The computer-implemented method of claim 1, wherein displaying to the user an indication of the current use of the resource comprises displaying a graphical bar on each slider, the length of the graphical bar corresponding to the amount of current use.

5. The computer-implemented method of claim 1, further comprising disabling access to the resource by a member if a slider bar is moved to a position on a slider where the allocation of the resource to the associated member is less than or equal to the current use by the member.

6. The computer-implemented method of claim 1, further comprising:
displaying to the user a group slider that is associated with the resource that is shared by the group of members; and
displaying to the user a slider bar on the group slider, wherein the position of the slider bar on the group slider reflects an aggregate allocation of the resource to all members in the group of members.

7. The computer-implemented method of claim 6, further comprising displaying to the user an indication of an aggregate current use of the resource by all members in the group of members.

8. The computer-implemented method of claim 7, wherein displaying an indication of an aggregate current use comprises displaying a graphical bar on the group slider, the length of the graphical bar corresponding to the amount of aggregate current use.

9. The computer-implemented method of claim 6, wherein the slider bar on the group slider is automatically moved whenever the user moves a slider bar on any of the plurality of sliders.

10. A computing system that allows a user to manage use by members of a group of a shared resource, the computing system comprising:
a communication component that is configured to receive data reflecting a current use of a resource by each member of a group of members;
a user interface component that is configured to:
display to a user a plurality of sliders that are associated with the resource, each of the plurality of sliders being associated with a different member in the group of members and each of the plurality of sliders having an indication of the current use of the resource by the member associated with each slider; and
display to the user a slider bar on each of the plurality of sliders, each slider bar being moveable by the user on the corresponding slider, wherein the position of the slider bar on the corresponding slider reflects an allocation of the resource to the member associated with that slider; and
an analysis component that is configured to receive from the user a movement of a slider bar on one of the plurality of sliders and cause the resource to be allocated in accordance with the received movement of the slider bar.

11. The computing system of claim 10, wherein the resource is part of a shared telecommunications service plan.

12. The computing system of claim 11, wherein the resource is selected from the group consisting of minutes, messages, and downloads.

13. The computing system of claim 10, wherein the indication of the current use comprises the display of a graphical bar on each slider, the length of the graphical bar corresponding to the amount of current use.

14. The computing system of claim 10, wherein the analysis component is further configured to disable access to the resource by a member if a slider bar is moved to a position on a slider where the allocation of the resource to the associated member is less than or equal to the current use by the member.

15. The computing system of claim 10, wherein the user interface component is further configured to:
display to the user a group slider that is associated with the resource that is shared by the group of members; and
display to the user a slider bar on the group slider, wherein the position of the slider bar on the group slider reflects an aggregate allocation of the resource to all members in the group of members.

16. The computing system of claim 15, wherein the user interface component is further configured to display to the user an indication of an aggregate current use of the resource by all members in the group of members.

17. The computing system of claim 16, wherein the display of the aggregate current use comprises the display of a graphical bar on the group slider, the length of the graphical bar corresponding to the amount of aggregate current use.

18. The computing system of claim 15, wherein the user interface component is further configured to automatically move the slider bar on the group slider whenever the user moves a slider bar on any of the plurality of sliders.

19. A computer-readable storage medium comprising instructions for generating an interface that allows a user to allocate a resource to members of a group, the instructions, when executed by a processor, cause the processor to:
display to a user a plurality of sliders that are associated with a resource that is shared among a group of members, each of the plurality of sliders being associated with a different member in the group of members;
display to the user a slider bar on each of the plurality of sliders, each slider bar being moveable by the user on the corresponding slider, wherein the position of the slider bar on the corresponding slider reflects an allocation of the resource to the member associated with that slider;
display to the user a group slider that is associated with the resource that is shared by the group of members;
display to the user a group slider bar on the group slider, wherein the position of the group slider bar on the group slider reflects an aggregate allocation of the resource to all members in the group of members;
receive from the user a movement of a slider bar on one of the plurality of sliders; and
allocate the resource in accordance with the received movement of the slider bar.

20. The computer-readable storage medium of claim 19, wherein the resource is part of a telecommunications service plan.

21. The computer-readable storage medium of claim 20, wherein the resource is selected from the group consisting of minutes, messages, and downloads.

22. The computer-readable storage medium of claim 20, further comprising instructions that, when executed by the processor, cause the processor to disable access to the resource by a member if a slider bar is moved to a position on a slider where the allocation of the resource to the associated member is less than or equal to the current use by the member.

23. The computer-readable storage medium of claim 20, further comprising instructions that, when executed by the processor, cause the processor to:
retrieve data reflecting a current use of the resource by each member in the group of members; and
for each of the plurality of sliders, display to the user an indication of the current use of the resource by the member associated with each slider.

24. The computer-readable storage medium of claim 23, wherein the display to the user of an indication of the current use of the resource comprises the display of a graphical bar on each slider, the length of the graphical bar corresponding to the amount of current use.

25. The computer-readable storage medium of claim 23, further comprising instructions that, when executed by the processor, cause the processor to display to the user an indication of an aggregate current use of the resource by all members in the group of members.

26. The computer-readable storage medium of claim 25, wherein the display of an indication of the aggregate current use comprises the display of a graphical bar on the group slider, the length of the graphical bar corresponding to the amount of aggregate current use.

27. The computer-readable storage medium of claim 19, further comprising instructions that, when executed by the processor, cause the processor to automatically move the slider bar on the group slider whenever the user moves a slider bar on any of the plurality of sliders.
